(19) United States
(12) Patent Application Publication
(10) Pub. No.: US 2024/0079664 A1
(43) Pub. Date: Mar. 7, 2024

(54) BATTERY MODULE

(71) Applicant: HYUNDAI MOBIS CO., LTD., Seoul (KR)

(72) Inventor: Sang Chul JO, Yongin-si (KR)

(73) Assignee: HYUNDAI MOBIS CO., LTD., Seoul (KR)

(21) Appl. No.: 18/238,760

(22) Filed: Aug. 28, 2023

(30) Foreign Application Priority Data
Sep. 1, 2022 (KR) 10-2022-0110629

(51) Int. Cl. H01M 10/48; G01K 1/02; H01M 10/42; H01M 50/502

(52) U.S. Cl. CPC H01M 10/482; G01K 1/026; H01M 10/425; H01M 10/486; H01M 50/502

(57) ABSTRACT

A battery module includes a battery cell stack that includes at least one battery cell arranged on one side, a first bus bar coupling member disposed on one side of the battery cell stack, a second bus bar coupling member disposed on the other side of the battery cell stack and a sensing assembly including a first wire part and a second wire part that include both ends, a 1-2th connector that is formed at one end of the first wire part and the second wire part, a 2-2th connector that is formed at the other end of the first wire part, and a sensing unit that has one end electrically connected to the other end of the second wire part, senses temperatures of upper and lower sides of the battery cell stack, respectively, and is made of a flexible printed circuit board.

### CROSS-REFERENCE TO RELATED APPLICATIONS

This application claims priority under 35 U.S.C. § 119 to Korean Patent Application No. 10-2022-0110629, filed on Sep. 1, 2022, in the Korean Intellectual Property Office, the disclosure of which is incorporated herein by reference in its entirety.

### TECHNICAL FIELD

The following disclosure relates to a battery module, and more particularly, to a battery module including an integrated sensing assembly for sensing temperature and voltage of a battery

### BACKGROUND

A battery used in a conventional electric vehicle constitutes a cell module assembly using only a flexible printed circuit board (FPCB) for sensing upper temperature and voltage of the battery. However, as a device for cooling the battery is recently provided on the upper or lower side of the battery, there is a need to measure the temperatures of the upper and lower portions of the battery together.

In order to sense the temperatures of the upper and lower portions of the battery using the conventional flexible printed circuit board, a flexible printed circuit board should be provided at the upper and lower portions, respectively. As a result, as the use of relatively expensive flexible printed circuit boards increases, there was a problem in that cost increased and restrictions occurred in packaging.

### RELATED ART DOCUMENT

### Patent Document

Korean Patent Laid-open Publication No. 10-2022-0071007 A (Diagnosis Method for Battery Pack, Publication Date May 31, 2022)

### SUMMARY

An embodiment of the present invention is directed to providing a battery module that is economical and less restrictive in terms of packaging, including an integrated sensing assembly capable of measuring a voltage of a battery cell while sensing temperatures of upper and lower portions of the battery module.

In one general aspect, a battery module includes: a battery cell stack that includes at least one battery cell arranged on one side; a first bus bar coupling member that is disposed on one side of the battery cell stack to electrically connect the battery cells and includes a 1-1th connector; a second bus bar coupling member that is disposed on the other side of the battery cell stack to electrically connect the battery cells and includes a 2-1th connector; and a sensing assembly, in which the sensing assembly includes: a first wire part and a second wire part that include both ends; a 1-2th connector that is formed at one end of the first wire part and the second wire part; a 2-2th connector that is formed at the other end of the first wire part;

and a sensing unit that has one end electrically connected to the other end of the second wire part, senses temperatures of upper and lower sides of the battery cell stack, respectively, and is made of a flexible printed circuit board.

The sensing unit may include: a first sensor that senses a temperature of one side; a second sensor that senses a temperature of the other side; a first pad that is attached to one surface of the first sensor; and a second pad that is attached to one surface of the second sensor.

The battery module may further include: an end plate that is disposed to cover the sensing unit and has a first groove and a second groove respectively formed at positions corresponding to the first pad and the second pad.

The battery module may further include: an end plate that is disposed to cover the sensing unit and has a space on an upper surface thereof, in which the first wire part and the second wire part are partially disposed in the space. The end plate may include at least two or more protrusions arranged in a zigzag shape at both ends of an upper surface, and a portion of the first wire part and the second wire part may be disposed in a space between the protrusions.

The other end of the second wire part and one end of the sensing unit may be joined by soldering.

The battery module may further include a protection part that surrounds one end of the sensing unit and the other end of the second wire part.

The battery module may further include: an end plate that is disposed to cover the sensing unit and has a locking jaw protruding from a portion of an upper surface thereof, in which the protection part may contact the locking jaw.

The first wire part and the second wire part may each include at least two or more wires, and the wire may be a connecting wire.

### BRIEF DESCRIPTION OF THE DRAWINGS

FIG. 1 is a partially exploded perspective view of a battery module according to an embodiment of the present invention.

FIG. 2 is a partially enlarged view of a first bus bar coupling member illustrated in FIG. 1.

FIG. 3 is a coupled perspective view of a battery module according to an embodiment of the present invention.

FIG. 4 is a coupled perspective view of the battery module according to the embodiment of the present invention viewed from another angle.

FIG. 5 is a partially enlarged view of a first wire part, a second wire part, and a 1-2th connector illustrated in FIG. 1.

FIG. 6 is a partially enlarged view of a sensing assembly illustrated in FIG. 1.

FIG. 7 is a perspective view of an end plate of the battery module according to the embodiment of the present invention.

FIG. 8 is a partially enlarged view of a sensing assembly illustrated in FIG. 3.

### DETAILED DESCRIPTION OF MAIN ELEMENTS

110: Battery cell
210: First bus bar coupling member
211: 1-1th connector
212: External connector
213: First circuit board
220: Second bus bar coupling member
221: 2-1th connector
222: Second circuit board
300: Sensing assembly
310: First wire part
320: Second wire part
330: 1-2th connector
340: 2-2th connector
350: Sensing unit
351: First pad
352: Second pad
353: Body
400: End plate
410: Protrusion
421: First groove
422: Second groove
430: Locking jaw
500: Protection part
510: First cap
520: Second cap

### DETAILED DESCRIPTION OF EMBODIMENTS

Hereinafter, a preferred embodiment of a battery module according to the present invention will be described in detail with reference to the accompanying drawings.

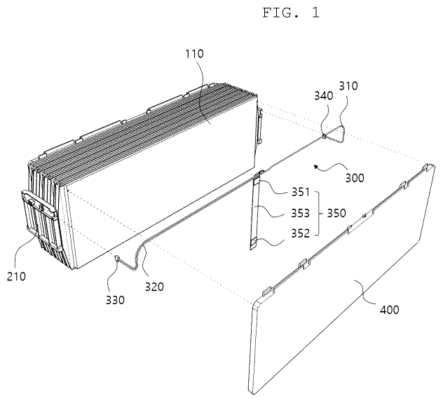

FIG. 1 is a partially exploded perspective view of a battery module according to an embodiment of the present invention.

The battery module according to an embodiment of the present invention includes a battery cell stack, a first bus bar coupling member 210, a second bus bar coupling member 220, a sensing assembly 300, and an end plate 400.

The battery cell stack includes at least one or more battery cells 110 arranged or stacked on one side. Referring to FIG. 1, the battery cell 110 may be a pouch-type battery cell 110, and a plurality of cells may be stacked in a diagonal direction from an upper left side to a lower right side.

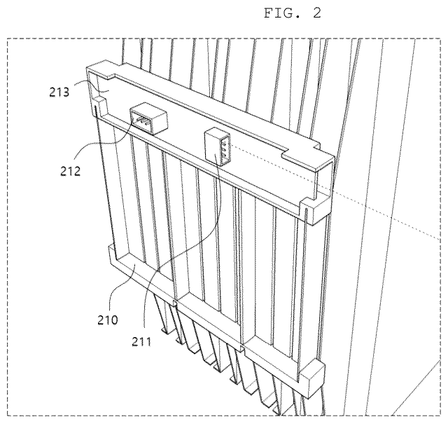

FIG. 2 is a partially enlarged view of a first bus bar coupling member illustrated in FIG. 1.

As illustrated in FIG. 2, the first bus bar coupling member 210 is disposed on one side of the battery cell stack to electrically connect the battery cells 110 to each other. The first bus bar coupling member 210 is formed on a 1-1th connector 211, a first circuit board 213 on which the 1-1th connector 211 is formed, and an external connector 212 that is formed on the first circuit board 213 and transmits the sensed voltage information and temperature information to the outside.

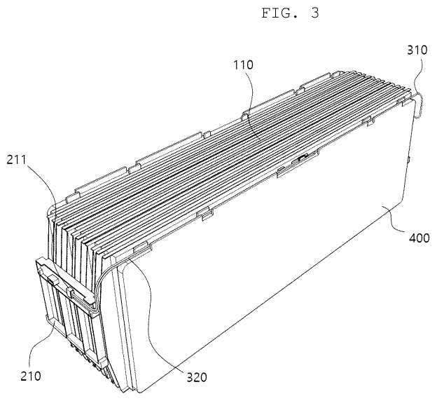

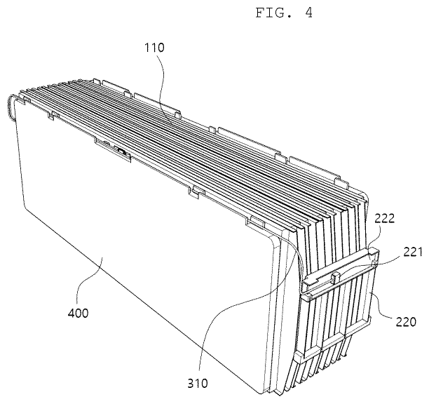

FIG. 3 is a coupled perspective view of the battery module according to the embodiment of the present invention, and FIG. 4 is a coupled perspective view of the battery module according to the embodiment of the present invention viewed from another angle.

Like the first bus bar coupling member 210, the second bus bar coupling member 220 is disposed on the other side of the battery cell stack to electrically connect the battery cells 110 to each other. Like the first bus bar coupling member 210, the second bus bar coupling member 220 may include a 2-1th connector 211 and a second circuit board 222 on which the 2-1th connector 211 is formed. When the external connector 212 is formed on only one of the first bus bar coupling member 210 and the second bus bar coupling member 220, since the external connector 212 does not need to be further formed, in the present embodiment, the external connector 212 may be formed on the first bus bar coupling member 210.

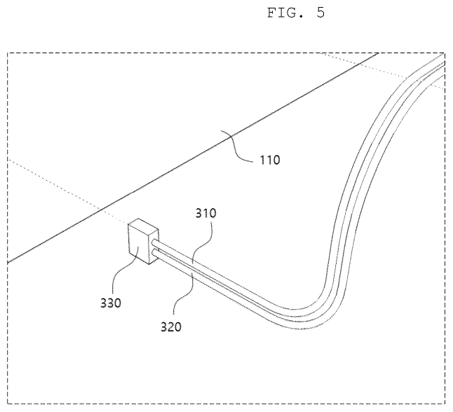

FIG. 5 is a partially enlarged view of a first wire part, a second wire part, and a 1-2th connector illustrated in FIG. 1.

The sensing assembly 300 is a member having the main technical features of the present invention, and as illustrated in FIGS. 1 and 5, a first wire part 310 that senses a voltage across the battery cell 110, a sensing unit 350 for sensing temperatures of upper and lower sides of the battery cell stack, respectively, and a second wire part 320 that electrically connects the sensing unit 350 to each other That is, in the present embodiment, the sensing assembly 300 is configured by integrating a wire part that senses the voltage across the battery cell 110, and a sensing unit that senses the temperatures of the upper and lower sides of the battery cell stack, respectively, which were conventionally configured separately. The present embodiment has a more advantageous effect in reducing cost and packaging the battery module through the integrated sensing unit 350 as described above.

The sensing assembly 300 may further include a 1-2th connector 330 and a 2-2th connector 340 in addition to the first wire part 310, the second wire part 320, and the sensing unit 350 described above.

The first wire part 310 and the second wire part 320 each include both ends. However, in the present embodiment, the extended length of the first wire part 310 is longer than the extended length of the second wire part 320. This is because the first wire part 310 should be physically connected to both ends of the battery cell 110 in order to sense the voltage across the battery cell 110, whereas this is because the second wire part 320 electrically connects a sensing unit 350 located in the middle of the battery cell stack to the outside.

The 1-2th connector 330 is formed at one end of the first wire part 310 and the second wire part 320 and coupled with the 1-1th connector 211 described above.

The 2-2th connector 340 is formed at the other end of the first wire part 310 and coupled with the 2-1th connector 211 described above.

As described above, the sensing unit 350 has one end electrically connected to the other end of the second wire part 320, senses the temperatures of the upper and lower sides of the battery cell stack, respectively, and is configured as a flexible printed circuit board. The reason why the sensing unit 350 senses the temperatures of the upper and lower sides of the battery cell stack, respectively, is that the battery cell 110 constituting the battery cell stack is cooled from the lower side due to a cooling method, so that the temperatures of the upper and lower sides of the battery cell stack are different. When the temperatures of the upper and lower sides of the battery cell 110 are different, the lifespan of the battery cell 110 is shortened. To overcome these limitations, the sensing unit 350 may sense the temperatures of the upper and lower sides of the battery cell stack, respectively, and the temperature information sensed may be used for management of the battery cell 110 to ultimately improve the lifespan of the battery cell 110. One end of the sensing unit 350 and the second wire part 320 may be joined using a soldering method. However, the present invention does not limit a method of joining one end of the sensing unit 350 and the other end of the second wire part 320 to soldering, and therefore, one end of the sensing unit 350 and the other end of the second wire part 320 through various methods may be joined to each other to be electrically connected to each other.

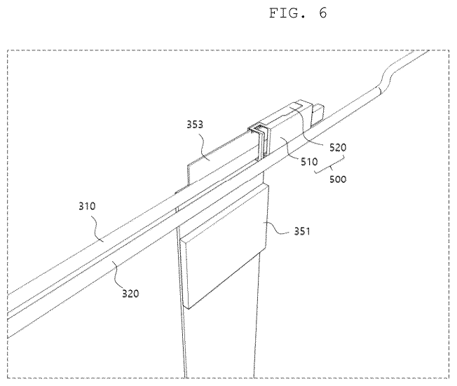

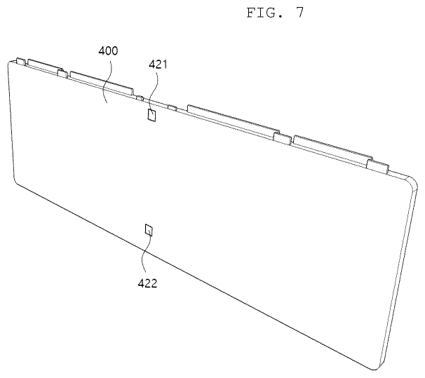

FIG. 6 is a partially enlarged view of the sensing assembly illustrated in FIG. 1, and FIG. 7 is a partially enlarged view of the sensing assembly illustrated in FIG. 3.

Referring to FIGS. 6 and 7, the sensing unit 350 includes a body 353, a first sensor, a second sensor, a first pad 351, and a second pad 352.

The body 353 is a part where the first sensor, the second sensor, the first pad 351 and the second pad 352 are disposed, one side of which is electrically coupled to the other end of the second wire part 320, and is disposed on the surface of the outermost battery cell 110 among the plurality of battery cells 110 constituting the battery cell stack. As described above, the body 353 may be manufactured as the flexible printed circuit board, so it may be freed from stress due to assembly errors or the like to some extent.

The first sensor and the second sensor are disposed on the upper and lower sides of the body 353, respectively, to sense the temperature of the portion where the sensor is located, that is, the upper and lower sides of the battery cell stack. The first sensor and the second sensor may be temperature sensors that generally sense temperature.

The first pad 351 and the second pad 352 are for preventing damage to the first sensor and the second sensor, and as illustrated in FIGS. 1 and 6, are attached on one surface of the first sensor and the second sensor, respectively. Both the first pad 351 and the second pad 352 may be made of a material having a certain level of elasticity or more. For example, the first pad 351 and the second pad 352 may be made of a material such as sponge or silicon.

FIG. 7 is a perspective view of an end plate of the battery module according to the embodiment of the present invention.

An end plate 400 is coupled to cover the outermost battery cell 110 of the battery cell stack, and serves to protect the battery cell stack. The end plate 400 may be made of a material having insulation and stiffness above a certain level. Since the end plate 400 is disposed to cover the outermost battery cell 110, a surface pressure may be applied to the sensing unit 350 disposed between the battery cell 110 and the end plate 400, which may cause damage to the first sensor and the second sensor included in the sensing unit 350. The first pad 351 and the second pad 352 are for preventing this, and in order to further maximize the effect of the first pad 351 and the second pad 352, on one surface of the end plate 400, a first groove 421 and a second groove 422 are formed on portions corresponding to the first pad 351 and the second pad 352, respectively, so pressure applied to the first sensor and the second sensor may be minimized.

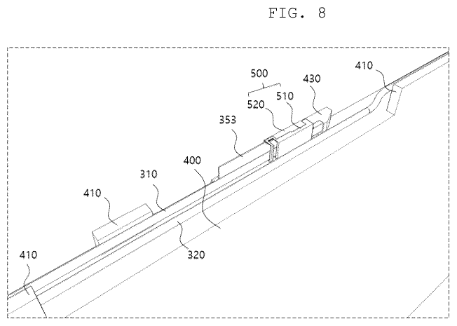

FIG. 8 is a partially enlarged view of a sensing assembly illustrated in FIG. 3.

As illustrated in FIG. 8, a plurality of protrusions 410 may be formed on the upper surface of the end plate 400.

The protrusion 410 is a member for disposing portions of the first wire part 310 and the second wire part 320 disposed on the upper surface of the end plate 400. The protrusions 410 each formed on both ends of the upper surface of the end plate 400 form a space therebetween, in which the first wire part 310 and the second wire part 320 are disposed in the space. In this case, the protrusions 410 are formed in a zigzag pattern based on the longitudinal direction of the upper surface of the end plate 400. This is to facilitate the arrangement and fixing of the first wire part 310 and the second wire part 320 while reducing the amount of material required to form the protrusions 410 by being formed in a zigzag pattern.

As illustrated in FIG. 8, the battery module according to the embodiment of the present invention may further include a protection part 500. The protection part 500 is a member for protecting the corresponding portion by covering one end of the sensing part 350 and the other end of the second wire part 320 that are joined to each other.

The protection part 500 may be implemented in various forms, and the protection part 500 according to the present embodiment may include a first cap 510 and a second cap 520 that are made of synthetic resin and assembled. The first cap 510 and the second cap 520 may be assembled to each other in a protrusion coupling structure. The protection part 500 may protect one end of the sensing unit 350 and the other end of the second wire part 320 joined to each other due to vibration applied to the battery module and swelling of the battery cell 110 through the structure of the first cap 510 and the second cap 520.

As illustrated in FIG. 8, the end plate 400 may include a locking jaw 430 protruding from a portion of the upper surface.

The locking jaw 430 is for seating the protection part 500, and the protection part 500 may come into contact with the locking jaw 430 to fix the sensing unit 350.

In the battery module according to the embodiment of the present invention, the first wire part 310 and the second wire part 320 may each be configured as a single wire, but may each include at least two or more wires. When the first wire part 310 and the second wire part 320 each include at least two or more wires, each of the plurality of wires may be a connecting wire arranged in one direction. In the present embodiment, the reason why the plurality of wires are configured as connecting wires is that the use of the connecting wire may make it easy to align and fix the wires at accurate positions even in a small space.

In the present embodiment, the wire parts included in each of the first wire part 310 and the second wire part 320 are configured as the connecting wire, or each of the wire included in the first wire part 310 and the wire included in the second wire part 320 may be configured as the connecting wire to each other.

According to the battery module according to the present invention as described above, a sensing assembly included in the battery module is configured in a form in which a wire and a flexible printed circuit board are integrated to sense a voltage across a battery cell and temperatures of upper and lower sides of a battery cell stack, thereby reducing costs and facilitating packaging compared to the related art in which the wire and the flexible printed circuit board are configured separately.

In addition, according to the present invention, a first wire part and a second wire part are disposed on an upper surface of an end plate, and wires included in the first wire part and the second wire part are formed as connecting wires, thereby facilitating packaging and wire alignment and fixing.

In addition, according to the present invention, protrusions formed on the upper surface of the end plate are formed in a zigzag pattern based on both ends of the upper surface to implement a kind of hook structure, and a portion of the first wire part and the second wire part is disposed between the protrusions, thereby preventing vibration from being transmitted to the wire and improving a fixing force of the wire.

In addition, according to the present invention, a first pad and a second pad are disposed on surfaces of a first sensor and a second sensor of a sensing unit, and a first groove and a second groove are formed in portions corresponding to the first pad and the second pad in an end plate to absorb a surface pressure applied to the first sensor and the second sensor, thereby preventing the first sensor and the second sensor from being damaged.

In addition, according to the present invention, a protection part is formed at a portion where the other end of the second wire part and one end of the sensing unit are joined to each other, thereby preventing damage to the joined part due to swelling of a battery cell.

The present invention is not limited to the above-mentioned embodiments, but may be variously applied, and may be variously modified without departing from the gist of the present invention claimed in the claims.

What is claimed is:

1. A battery module, comprising:
a battery cell stack that includes at least one battery cell arranged so that surfaces included in each face face each other;
a first bus bar coupling member that is disposed on one side of the battery cell stack to electrically connect the battery cells and includes a 1-1th connector;
a second bus bar coupling member that is disposed on the other side of the battery cell stack to electrically connect the battery cells and includes a 2-1th connector; and
a sensing assembly,
wherein the sensing assembly includes:
a first wire part and a second wire part that include both ends;
a 1-2th connector that is formed at one end of the first wire part and the second wire part;
a 2-2th connector that is formed at the other end of the first wire part; and
a sensing unit that has one end electrically connected to the other end of the second wire part, senses temperatures of upper and lower sides of the battery cell stack, respectively, and is made of a flexible printed circuit board.

2. The battery module of claim 1, wherein the sensing unit includes:
a first sensor that senses a temperature of one side;
a second sensor that senses a temperature of the other side;
a first pad that is attached to one surface of the first sensor; and
a second pad that is attached to one surface of the second sensor.

3. The battery module of claim 2, further comprising:
an end plate that is disposed to cover the sensing unit and has a first groove and a second groove respectively formed at positions corresponding to the first pad and the second pad.

4. The battery module of claim 1, further comprising:
an end plate that is disposed to cover the sensing unit and has a space on an upper surface thereof, the first wire part and the second wire part being partially disposed in the space.

5. The battery module of claim 4, wherein the end plate includes at least two or more protrusions arranged in a zigzag shape at both ends of the upper surface, and
a portion of the first wire part and the second wire part is disposed in a space between at least two of the protrusions arranged in the zigzag shape.

6. The battery module of claim 1, wherein the other end of the second wire part and one end of the sensing unit are joined by soldering.

7. The battery module of claim 1, further comprising:
a protection part that surrounds one end of the sensing unit and the other end of the second wire part.

8. The battery module of claim 7, further comprising:
an end plate that is disposed to cover the sensing unit and has a locking jaw protruding from a portion of an upper surface thereof,
wherein the protection part contacts the locking jaw.

9. The battery module of claim 1, wherein the first wire part and the second wire part each include at least two or more wires, and
a wire of the at least two or more wires is a connecting wire.
